(19) United States
(12) Patent Application Publication
(10) Pub. No.: US 2025/0173046 A1
(43) Pub. Date: May 29, 2025

(54) METHOD FOR DETERMINING VIEW EXPOSURE STATE AND RELATED DEVICE

(71) Applicant: Lemon Inc., Grand Cayman (KY)

(72) Inventors: Guannan Wang, Culver City, CA (US); Jianming Gu, Beijing (CN)

(21) Appl. No.: 18/961,855

(22) Filed: Nov. 27, 2024

(30) Foreign Application Priority Data
Nov. 28, 2023 (CN) 202311612498.2

(51) Int. Cl. G06F 3/0483; G06F 3/0485

(52) U.S. Cl. CPC G06F 3/0483; G06F 3/0485; G06F 2203/04804

(57) ABSTRACT

The disclosure provides a method for determining a view exposure state, including: in response to detecting that a display state of a view changes, determining a current exposure state of the view based on a historical exposure state of the view and an exposure related parameter of the view, the historical exposure state including an exposure state of the view before the display state of the view changes, the view including a list view; and polling, at a predetermined time interval, the historical exposure states of all list views of a page on which the list view is located, and determining a current exposure state of each of the list views based on the historical exposure state and the exposure related parameter of each of the list views. Further provided are an apparatus, an electronic device, a storage medium, and a program product for determining a view exposure state.

### CROSS REFERENCE

This application claims priority of Chinese Patent Application No. CN202311612498.2, filed on Nov. 28, 2023, entitled ‘Method for Determining View Exposure State and Related Device’.

### FIELD

The present disclosure relates to the field of view exposure technologies, and in particular, to a method for determining a view exposure state and a related device.

### BACKGROUND

For a program, view exposure is an important user perceived event. With the rapid development of Internet technologies and applications, a user has an increasingly high requirement on the accuracy of pushed content. In this case, it is necessary to determine personal preferences of the user according to exposure conditions of the user browsing a view, thereby pushing content with higher quality to the user.

Currently, there is generally a simple logic control for the exposure state of a single type of view. However, for a multi-type view, there is no complete set of logic system for determining the exposure state of the multi-type view. In addition, the logic system in the prior art is generally simple, and cannot precisely control the exposure state of the view, and cannot ensure the timeliness of the update of the exposure state of the view.

### SUMMARY

In view of this, an objective of the present disclosure is to provide a method for determining a view exposure state and a related device.

Based on the foregoing objective, the present disclosure provides a method for determining a view exposure state, comprising:
in response to detecting that a display state of a view changes, determining a current exposure state of the view based on a historical exposure state of the view and an exposure related parameter of the view, the historical exposure state comprising an exposure state of the view before the display state of the view changes, the view comprising a list view;
polling, at a predetermined time interval, the historical exposure states of all list views of a page on which the list view is located, and determining a current exposure state of each of the list views based on the historical exposure state and the exposure related parameter of each of the list views.

Based on the foregoing method for determining an exposure state of a view, an embodiment of the present disclosure provides an apparatus for determining an exposure state of a view, comprising:
a determining module configured to, in response to detecting that a display state of a view changes, determine a current exposure state of the view based on a historical exposure state of the view and an exposure related parameter of the view, the historical exposure state comprising an exposure state of the view before the display state of the view changes, the view comprising a list view;
a polling module configured to poll, at a predetermined time interval, the historical exposure states of all list views of a page on which the list view is located, and determine a current exposure state of each of the list views based on the historical exposure state and the exposure related parameter of each of the list views.

In addition, the embodiments of the present disclosure also provide an electronic device, comprising a memory, a processor and a computer program stored in the memory and executable on the processor, wherein when executing the program, the processor implements the foregoing method.

Embodiments of the present disclosure further provide a non-transitory computer-readable storage medium. The non-transitory computer-readable storage medium stores computer instructions, wherein the computer instructions are used to cause a computer to implement the foregoing method.

Embodiments of the present disclosure also provide a computer program product comprising computer program instructions, wherein the computer program instructions, when running on a computer, cause a computer to implement the foregoing method.

It can be seen from the foregoing contents that, by means of a method and a related device for determining an exposure state of a view provided in the present disclosure, a current exposure state of a view is determined on the basis of a historical exposure state of the view and an exposure related parameter of the view, in response to detecting that a display state of a view changes; the historical exposure state comprises an exposure state of the view before the display state of the view changes; the view comprises a list view; polling, at a predetermined time interval, the historical exposure states of all list views of a page on which the list view is located, and determining a current exposure state of each of the list views based on the historical exposure state and the exposure related parameter of each of the list views. The foregoing method can adjust a plurality of types of view exposure states under a set of logic systems, and an exposure-related parameter is also introduced to adjust an exposure state of a view, so that the exposure state of the view can be controlled more precisely. In addition, a polling mode capable of polling the exposure state of the list view at a predetermined time interval and determining the exposure state of the view at a predetermined time interval is additionally provided. This effectively ensures real-time updating of the view exposure state, and further implements accurate control over the view exposure state. It can be seen that the foregoing method can effectively solve the problem of lacking a complete set of logic system for determining an exposure state of a multi-type view and the problem of the adjustment logic for the exposure state of the view is too simple to accurately determine the exposure state and cannot ensure the timeliness of the update of the exposure state of the view.

### BRIEF DESCRIPTION OF THE DRAWINGS

To describe the technical solutions in the present disclosure or the technical solutions in the related art more clearly, the following briefly introduces the accompanying drawings required for describing the embodiments or the related art. Apparently, the accompanying drawings in the following description show merely embodiments of the present disclosure, and a person of ordinary skill in the art may still derive other drawings from these accompanying drawings without creative efforts.

FIG. 1 shows an implementation flow of a method for determining a view exposure state according to some embodiments of the present disclosure;

FIG. 2 shows an implementation flow of determining an exposure state of a normal view according to an embodiment of the present disclosure;

FIG. 3 is an implementation flow of determining an exposure state of a list view according to an embodiment of the present disclosure;

FIG. 4 shows an implementation flow of polling at a predetermined time interval according to an embodiment of the present disclosure;

FIG. 5 shows an inner structure of an apparatus for determining an exposure state of a view according to an embodiment of the present disclosure;

FIG. 6 is a schematic diagram of a more specific hardware structure of an electronic device according to some embodiments of the present disclosure.

### DETAILED DESCRIPTION

In order to make objects, technical solutions and advantages of the present disclosure more apparent, the present disclosure will be further described in detail below in conjunction with specific embodiments and with reference to the accompanying drawings.

It should be noted that, unless otherwise defined, technical terms or scientific terms used in the embodiments of the present disclosure should have a common meaning understood by those skilled in the art. The terms ‘first’, ‘second’, and the like used in the embodiments of the present disclosure do not indicate any order, quantity, or importance, but are only used to distinguish different components. Words of “comprising” or “including” and the like mean that the element or item before the word appears to encompass the element or item listed after the word and equivalents thereof, without excluding other elements or items. Words such as “connected” or “in connection” are not limited to physical or mechanical connections, but may include electrical connections, whether direct or indirect. The terms “upper”, “lower”, “left”, “right” and the like are only used for representing the relative position relationship, and in a case that the absolute position of the described object changes, the relative position relationship may also change correspondingly.

It should be understood that, before the technical solutions of the embodiments of the present disclosure are used, the user is notified of the type, usage range, usage scenario, and the like of the concerned personal information in an appropriate manner, and the authorization of the user is obtained.

For example, in response to receiving an active request from a user, prompt information is sent to the user so as to explicitly prompt the user that an operation requested by the user needs to acquire and use personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request of a user, a manner of sending prompt information to the user may be, for example, a manner of a pop-up window, where the pop-up window may present the prompt information in a text manner. In addition, the pop-up window may also carry a selection control for the user to select ‘agree’ or ‘don't agree’ to provide personal information to the electronic device.

It can be understood that, the above processes of notifying and obtaining the user authorization are only illustrative, and do not limit the implementation of the present disclosure, and other methods meeting relevant legal regulations may also be applied to the implementation of the present disclosure.

As described above, at present, a simple logic control for the exposure state of a single type of view generally exists. However, for a multi-type view, there is no complete logic system for determining the exposure state of the multi-type view at present. In addition, the logic system in the prior art is generally simple, cannot precisely control the exposure state of the view, and cannot ensure the timeliness of the update of the exposure state of the view.

To this end, some embodiments of the present disclosure provide a method for determining a view exposure, which can adjust a plurality of types of view exposure states in a set of logic systems, and an exposure related parameter is also introduced to adjust an exposure state of a view, so that the exposure state of the view can be controlled more precisely. In addition, a polling mode capable of polling the exposure state of the list view at a predetermined time interval and determining the exposure state of the view at a predetermined time interval is additionally provided. This effectively ensures real-time updating of the view exposure state, and further implements accurate control over the view exposure state. In an embodiment of the present disclosure, the above-described method for determining the view exposure state may be implemented by an electronic device having computing capability.

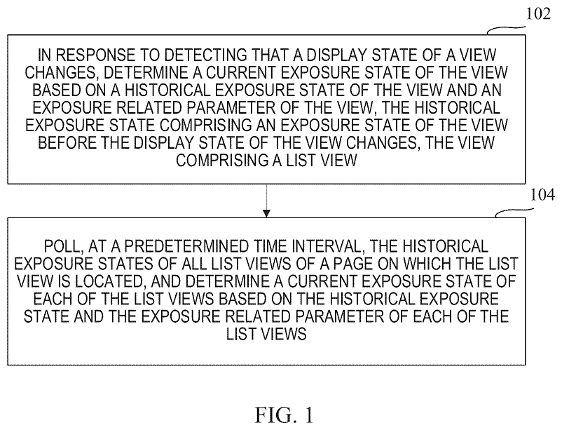

FIG. 1 shows an implementation flow of a method for the view exposure state according to an embodiment of the present disclosure. As shown in FIG. 1, the method may include the following steps:

at step 102, in response to detecting that a display state of a view changes, determine a current exposure state of the view based on a historical exposure state of the view and an exposure related parameter of the view, the historical exposure state comprising an exposure state of the view before the display state of the view changes, the view comprising a list view.

It should be clear first of all that for the present disclosure, a complete control logic is provided for the multi-type view, and the control logic is built under a set of control frames. The present disclosure is provided with an exposure manager under which at least one exposure group is managed, and at least one exposure item is managed under each exposure group. Wherein each exposure group corresponds to a view controller, into which the exposure targets in the view controller are associated. Each exposure item corresponds to a specific exposure target which may be a common view or a list view. For each exposure item, a corresponding exposure configuration is further set.

The foregoing common view refers to a general view displayed on an interface, which may be, for example, a button or an image. The foregoing list view is a view having a specific format, which may be specifically embodied in a form of a list. The list view is further divided into a single-column list view and a multi-column list view. A list view with different numbers of columns may be controlled by using different controllers in actual controls.

In an embodiment of the present disclosure, the above display changing state of the view may include a view appearance, a view disappearance, a sub-view rearrangement, a sub-view moving to the parent view, a sub-view moving out of the parent view, a view hiding, etc.

In the embodiments of the present disclosure, the foregoing detection of the display state changing of the view may be implemented by using a hook method.

The Windows system is built on an event driven mechanism, that is, the entire system is implemented through message transmission. Hook is a special message processing mechanism, which can monitor various event messages in a system or process, and capture messages sent to a target window and perform processing. Hence, we can define a hook in the system for monitoring the appearance of a specific event in the system and accomplishing a specific function, such as fetching a word from a screen, monitoring logs, capturing keyboard and mouse inputs, etc. There are many types of hooks, and each type of hook can capture a corresponding message, for example, a keyboard hook can capture a keyboard message, and a shell hook can capture, start and close an application program, etc. Hooks can be divided into thread hooks and system hooks, wherein thread hooks can monitor event messages of a specified thread, and system hooks monitor event messages of all threads in a system. Hence, the hook is a mechanism for intercepting a Windows message, and the hook may intercept messages (thread hooks) of a single process, and the hook may intercept messages (system hooks) of all processes, and the hook may also perform customized processing on the intercepted messages. In the embodiments of the present disclosure, a display state of a view is monitored by using a hook.

After detecting the display state of the view changes, the exposure state of the current view needs to be determined according to predetermined logic. When monitoring a display state of a view, a change in the display state of the view may be known by monitoring a life cycle of the view.

In an embodiment of the present disclosure, the exposure related parameter of the view may include an exposure area of the view, a transparency of the view, a location of the view, and an exposure time of the view. The current exposure state of the view may be known according to the foregoing exposure related parameter, but it should be noted that in embodiments of the present disclosure, the exposure state of a view can not only be determined according to exposure related parameters, and other additional complex logic for assisting in determining the exposure state of a view may also be included, as detailed below.

In an embodiment of the present disclosure, the above-mentioned historical exposure state of the view is the exposure state of the view before the display state changing of the view, that is, the exposure state maintained by the view before determining a new exposure state of the view. In this embodiment, when determining an exposure state of a view, sometimes it is necessary to assist in determining a current exposure state of the view according to a historical exposure state of the corresponding view, that is, if the historical exposure states of the view are different, the current exposure states of the finally determined view may be different. Since different logical branches may exist for different historical exposure states, the historical exposure state of the view may also be an important parameter for determining the current exposure state of the view.

The exposure state of a view may include unexposed, in exposure, and exposed. For a view, the exposure state of the view may be a temporary quantity of state within a period of time, and in the embodiment of the present disclosure, the exposure state of the view flows among the foregoing three states.

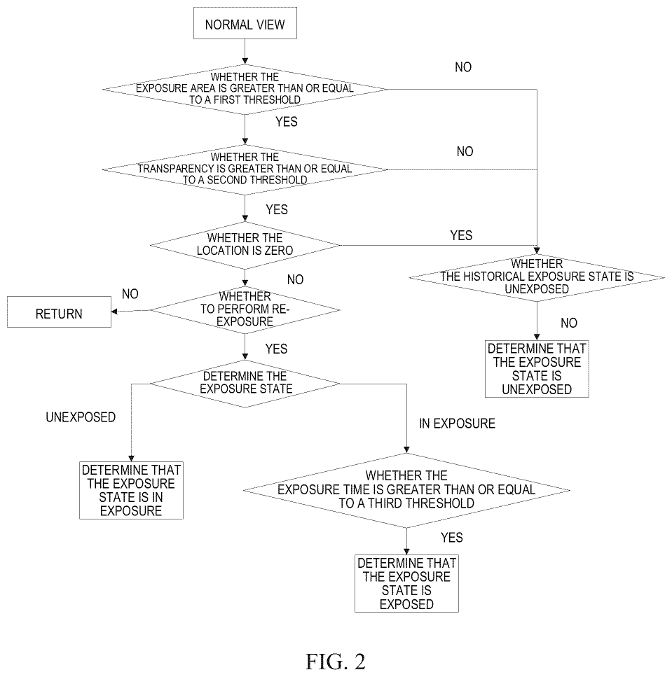

FIG. 2 shows an implementation flow of determining an exposure state of a normal view according to an embodiment of the present disclosure.

In an embodiment of the present disclosure, the exposure related parameter comprises an exposure area of the view, a transparency of the view and a location of the view; the determining the current exposure state of the view based on the historical exposure state of the view and the exposure related parameter of the view comprises: in response to the exposure area being greater than a first threshold, the transparency being greater than a second threshold, and the location being on a visible page, determining the current exposure state of the view to be exposed.

As shown in FIG. 2, in an embodiment of the present disclosure, it is determined whether an exposure area of a view is greater than a first threshold, if the exposure area of a view is greater than the first threshold, continue to determine whether the transparency of the view is greater than a second threshold, and if the transparency of the view is greater than the second threshold, then continuing to determine whether the view location is zero, and in a case that the view location is zero, the view cannot be located on the visible page, in other words, the view cannot appear on the current display page. In a case that the view location is not zero, the view appears on the current page. In some other embodiments, it may be determined that the exposure state of the view is in exposure. In a case that any one of the foregoing three determining conditions is not satisfied, it can be learned that the exposure state of the view at this time is unexposed, and the exposure state of the view is also correspondingly determined. In some embodiments, if the historical exposure state of the view is in exposure or exposed, it may be determined that the exposure state of the view is unexposed.

It should be noted that FIG. 2 only provides an example of a determining order for the three determining conditions, and the three determining conditions may actually change in order, which does not affect determining the exposure state of the final view.

In an embodiment of the present disclosure, after determining that the current state of the view is exposed, further comprises: determining whether the view requires re-exposure; in response to the view requiring re-exposure, re-determining a current exposure state of the view based on the historical exposure state of the view and an exposure related parameter of the view.

With continued reference to FIG. 2, in a case that all the foregoing three determining conditions are satisfied, the problem of whether the re-exposure is required for a view may also be considered at this time. In the embodiments of the present disclosure, by adding a determination about whether the re-exposure is required for the view, the exposure state of the view is determined more accurately. Specifically, as shown in FIG. 2, in a case that it is determined that the view requires to be re-exposed, the historical exposure state of the view at this time is continuously being determined. If the historical exposure state is unexposed, it is determined that the exposure state of the view is in exposure at this time, and if the historical exposure state is in exposure, in this case, a further determination needs to be performed, which specifically is determining whether the exposure time is greater than or equal to the third threshold, and if the condition is satisfied, it is determined that the exposure state of the view is exposed.

In an embodiment of the present disclosure, the display state changing comprising an appearance event and a disappearance event; in response to detecting that the display state of the view changes, determining the current exposure state of the view based on the historical exposure state of the view and the exposure-related parameter of the view comprises: in response to detecting an appearance event of the list view, determining the current exposure state of the list view to be in exposure; in response to detecting a disappearance event of the list view, determining the current exposure state of the list view based on the historical exposure state of the list view and the exposure related parameter of the list view.

In the embodiments of the present disclosure, the foregoing appearance event refers to that a certain row in the list view is about to appear, and the foregoing disappearance event refers to that a certain row in the list view has disappeared.

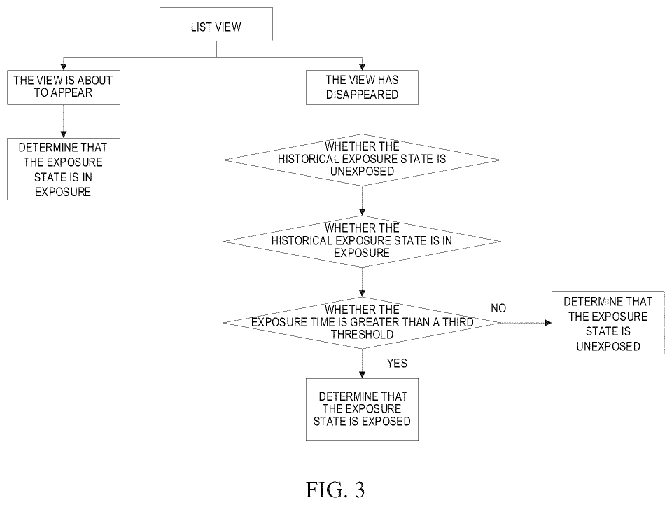

FIG. 3 shows an implementation flow of determining an exposure state of a list view according to an embodiment of the present disclosure.

In an embodiment of the present disclosure, the exposure related parameter comprises an exposure time of the view; the determining the current exposure state of the list view based on the historical exposure state of the list view and the exposure related parameter of the list view comprises: in response to the historical exposure state of the list view being in exposure, and the exposure time being greater than or equal to a third threshold, determining the current exposure state of the list view to be exposed; in response to the historical exposure state of the list view being in exposure, and the exposure time being less than the third threshold, determining the current exposure state of the list view to be unexposed.

In a case that the view is a list view, if it is detected at this time that a row having a list view is about to appear, for the present disclosure, it may be determined first whether the exposure of the list of the row is turned on, where the exposure of the list being turned on means that the list requires an exposure, and if the exposure of the list of the row is not turned on, it means that the row does not require an exposure, and therefore, the operation is directly return. After exposure of a list is turned on, it is determined whether there is a corresponding exposure group in an exposure group of an existing logical frame that can manage the list view with respect to the list view, if not, a corresponding exposure group is created, and continuing to determine next, whether there is a corresponding exposure item that can manage the list view with respect to the list view, if not, a corresponding exposure item is created, and at this moment, a determination step is further required, i.e. determining whether the override mode is turned on, however, at present, in the description, it is defaulted that the override mode is not turned on, and therefore, it is directly confirmed that the current exposure state of the list view is in exposure. The foregoing creation of the exposure group and the exposure item is created as required, that is, in a case that a certain view needs to be exposed, the exposure group and the exposure item may be created on their own.

If it is detected that the row of the list view has disappeared at this time, at this time, similarly, it is required to firstly determine whether the exposure of the list is turned on, and if it is not turned on, it is directly returned, and if it is turned on, it is determined whether the override mode is turned on, and here, it is not turned on by default at the time of description (if it is turned on, then it is directly returned at this time), and at this time, the current exposure state of the list view can be determined based on the historical exposure state of the list view. Specifically, referring to FIG. 3, in a case that the historical exposure state of the list view is not unexposed, it is determined whether the historical exposure state is in exposure, if yes, continue to determine whether the exposure time of the list view is greater than or equal to a third threshold, if the condition is satisfied, determining that the exposure state of the list view is exposed, and if the condition is not satisfied, determine that the exposure state of the list view is unexposed. Here, since the exposure time does not reach the third threshold value during the exposure, and the event at this time is that the row of the list view have already disappeared, and the condition for the exposure state being exposed cannot be satisfied. Therefore, it is determined that the exposure state of the list view is unexposed.

In an embodiment of the present disclosure, the method further comprises: in response to detecting a scroll stop event of the list view, polling the historical exposure states of all list views of the page on which the list view is located, and determining a current exposure state of each of the list views based on the historical exposure state and the exposure related parameter of each of the list views.

In an embodiment of the present disclosure, the scroll stop event of the list view is monitored, if the occurrence of the scroll stop event is detected, likewise, it is required to first determine whether an exposure switch corresponding to the list view is turned on, and if yes, polling historical exposure states of all list views of a page on which the list view is located, i.e. traversing all the rows to be determined in the page, specifically, the exposure group corresponding to the page is obtained, and during the obtaining process, the obtaining process is performed in a manner where a single view controller is regarded as a unit. After the corresponding exposure group is obtained, all the exposure items in the exposure group are traversed, and subsequent detailed logic determination is performed.

In step 104, the historical exposure states of all list views of a page on which the list view is located are polled at a predetermined time interval, and a current exposure state of each of the list views is determined based on the historical exposure state and the exposure related parameter of each of the list views.

In the embodiments of the present disclosure, polling at a predetermined event interval is to cope with these situations: firstly, the situation that the user stays still, if the user stays still, the life cycle of the hook does not change for all the views at this time. Therefore, the display state changes will not be detected, and the exposure states of these views do not change at this time. If the user stays still, the exposure state cannot be updated all the time, and the exposure of the view is required to be timely, if a certain view reaches a corresponding threshold at this time, an exposure state of the view should be changed to be in exposure or exposed. However, because the user stays still, the corresponding life cycle cannot be hooked, and the exposure state corresponding thereto does not change. Obviously, this is not beneficial for updating the exposure state of a view, and therefore the present disclosure sets a polling mechanism, i.e. updating the exposure state of all list views at a predetermined time interval. This effectively ensures the timeliness of the view exposure state update. Secondly, in the present disclosure, a corresponding override mode is set. In this mode, the present disclosure may determine an exposure state of a view by means of some new logic. After the override mode is enabled, the exposure state of the view may be determined not necessarily depending on the foregoing life cycle method, and the exposure state of the view may be determined by directly polling internally, and a manual check on the exposure state of the view may be implemented.

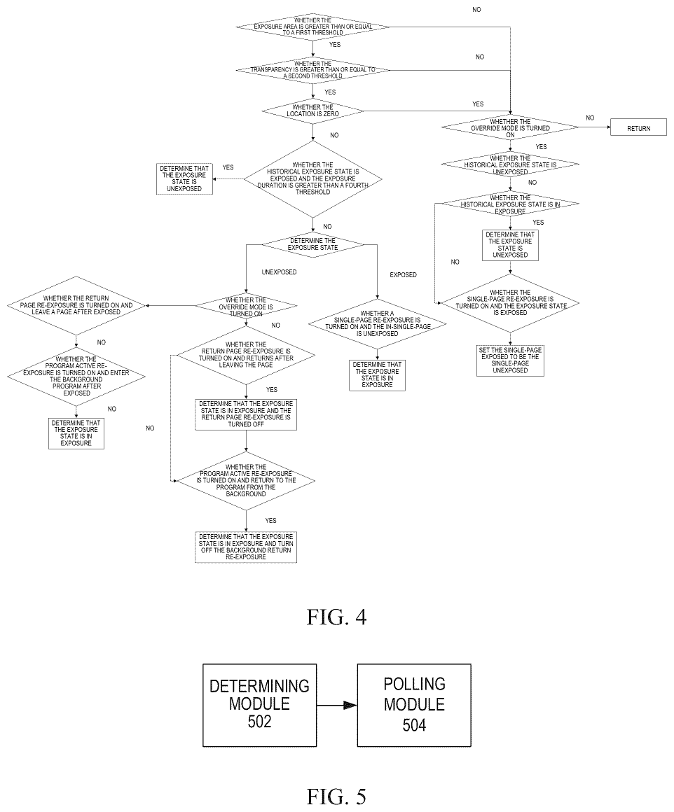

In an embodiment of the present disclosure, determining the current exposure state of each of the list views based on the historical exposure state and the exposure related parameter of each of the list views further comprises: for each of the list views, obtaining a re-exposure parameter of the list view; determining the current exposure state of the list view based on the re-exposure parameter, the historical exposure state, and the exposure related parameter; wherein the re-exposure configuration comprises: an in-single-page re-exposure parameter, a background return re-exposure parameter, a page return re-exposure parameter, and a program active re-exposure parameter; the in-single-page re-exposure parameter is used to control whether the list view in a single page is re-exposed; the background return re-exposure parameter is used to control whether the list view displayed after being returned by the background is re-exposed; the page return re-exposure parameter is used to control whether the list view displayed after returning to a page is re-exposed; the program active re-exposure parameter is used to control whether the list view displayed after a program is active is re-exposed. The foregoing embodiments are described in detail with reference to FIG. 4.

FIG. 4 shows an implementation flow of polling at a predetermined time interval according to an embodiment of the present disclosure.

Specifically, in the polling process, it is first determined whether the exposure area is greater than or equal to a first threshold, and whether the transparency is greater than or equal to a second threshold, whether the position is zero, and if any one of the three items does not satisfy the requirements, whether the override mode is turned on is determined at this time, if the override mode is not turned on, directly return, and if the override mode is turned on, determine whether the historical exposure state is in exposure, if the historical exposure state is in exposure, determine that the exposure state is unexposed, and if the historical exposure state is not in exposure and is not unexposed, then at this time, determine whether the single-page re-exposure is turned on and the exposure state is exposed, and if yes, setting the single page exposed to be single page unexposed. Since the exposure state of the view at this moment is exposed, and a single-page re-exposure is turned on, it is necessary to set the single-page exposed to be the single-page unexposed, so as to re-expose the view subsequently.

If the requirements are met in the process of determining the exposure area, the transparency and the position, it is determined whether the historical exposure state is exposed and the exposure duration is greater than a fourth threshold at this time, if the requirements are satisfied, determining that the current exposure state is unexposed, and if the requirements are not satisfied, then determining the historical exposure state, if the historical exposure state is exposed, then determine whether a single-page re-exposure is turned on and the in-single-page is not exposed, and if the requirements are satisfied, then, the exposure state is determined to be in exposure, and re-exposure starts. However, if it is determined that the foregoing historical exposure state is unexposed, it is determined whether the override mode is turned on at this time. If the override mode is not turned on, it is determined whether the return page re-exposure is turned on and a behavior that the user returns after the user leaves the page is performed, if the requirements are satisfied, determining that an exposure state is in exposure state and turning off the return page re-exposure, and if the requirements are not satisfied, it is determined whether the program active re-exposure is turned on and the user returns to the program from the background, and if the requirements are satisfied, determining that the exposure state is in exposure and turning off the background return re-exposure. Here, the purpose of turning off the background return re-exposure is to prevent the problem of infinite re-exposure from occurring.

In the above determining process, if the override mode is turned on, it is determined whether the return page re-exposure has been turned off and the page has been left after being exposed, if the requirements are not satisfied, continuing to determine whether the program active re-exposure is turned off and a background program is entered after being exposed, If it still does not satisfy the requirements, it is determined that the current exposure state of the view is in exposure, and in the foregoing process, if the requirements are satisfied, then return directly, the exposure state is not modified.

The foregoing polling scheme and the scheme for determining the view exposure state for the life cycle are executed in parallel. The parallel technical solution of a life cycle monitoring method and a polling method can effectively ensure the timeliness of the update of a view exposure state. Furthermore, in the polling scheme, the behavior of re-exposure is defined in detail, and the situation of re-exposure is further clarified, and the problem of infinite re-exposure is avoided effectively through various logic determination and parameter setting.

In an embodiment of the present disclosure, the method further comprises: setting a target view, the target view being located on a first page; in response to an event of switching the first page to a second page, re-determining a current exposure state of the target view; wherein the first page and the second page are controlled by a same view controller.

In the prior art, for a first page and a second page controlled by the same view controller, if a user only switches between the first page and the second page, then a life cycle event cannot be detected, and at this time, for a page controlled by the same view controller, when switching between the pages, the exposure state of the view in the page cannot be updated in time. For this reason, in the present disclosure, a target view is set, and for a user, the target view can be selected and configured of one's accord. After the target view is set, when monitoring, the life cycle event of the target view is monitored separately, that is, if the display state of the target view changes, at this time, it may be triggered to re-determine the current exposure state of the corresponding target view. The foregoing solution can effectively solve the technical problem that the view exposure state of a plurality of pages controlled by a single view controller cannot be updated in time when the single view controller controls the plurality of pages.

The foregoing method for determining an exposure state of a view comprises: by detecting that a display state of a view changes, determining a current exposure state of the view based on a historical exposure state of the view and an exposure related parameter of the view; the historical exposure state comprising an exposure state of the view before the display state of the view changes, the view comprising a list view; and polling, at a predetermined time interval, the historical exposure states of all list views of a page on which the list view is located, and determining a current exposure state of each of the list views based on the historical exposure state and the exposure related parameter of each of the list views. A plurality of types of view exposure states can be adjusted under a set of logic system, and exposure related parameters is also introduced to adjust the exposure state of a view. The exposure state of a view can be controlled more precisely. In addition, a polling mode is additionally set. It is able to poll the exposure status of the list view at predetermined time intervals and determine the exposure status of the view at predetermined time intervals. This effectively ensures real-time updating of the view exposure state, and further implements accurate control over the view exposure state. It can be seen that the foregoing method can effectively solve the problem of lacking a complete set of logic system for determining an exposure state of a multi-type view and the problem of the adjustment logic for the exposure state of the view is too simple to accurately determine the exposure state and cannot ensure the timeliness of the update of the exposure state of the view.

It should be noted that the method according to the embodiments of the present disclosure may be executed by a single device, such as a computer or a server. The method in this embodiment may also be applied to a distributed scenario, and a plurality of devices may cooperate with each other to complete the method. In this distributed scenario, one of the plurality of devices may execute only one or more steps in the method according to the embodiment of the present invention, and the plurality of devices interact with each other to implement the method.

It should be noted that some embodiments of the present disclosure have been described above, and other embodiments are within the scope of the appended claims. In some cases, the actions or steps recited in the claims may be performed in a different order than in the embodiments described above and still achieve desirable results. In addition, the processes depicted in the figures do not necessarily require the particular order shown, or sequential order, to achieve desirable results. In certain embodiments, multitasking and parallel processing may be performed or may be advantageous.

Corresponding to the method for determining an exposure state of a view, an embodiment of the present disclosure further discloses an apparatus for determining an exposure state of a view. FIG. 5 shows an internal structure of the apparatus for determining the exposure state of a view according to an embodiment of the present disclosure. As shown in FIG. 5, the apparatus may include:
a determining module 502, configured to, in response to detecting that a display state of a view changes, determine a current exposure state of the view based on a historical exposure state of the view and an exposure related parameter of the view, the historical exposure state comprising an exposure state of the view before the display state of the view changes, the view comprising a list view;
a polling module 504, configured to poll, at a predetermined time interval, the historical exposure states of all list views of a page on which the list view is located, and determine a current exposure state of each of the list views based on the historical exposure state and the exposure related parameter of each of the list views.

In some embodiments of the present disclosure, the exposure related parameter comprises an exposure area of the view, a transparency of the view, and a location of the view;

The determining module 502 may include:
a first determining unit configured to, in response to the exposure area being greater than a first threshold, the transparency being greater than a second threshold, and the location being on a visible page, determine the current exposure state of the view to be exposed.

In some embodiments of the present disclosure, the apparatus further comprises:
a re-exposure module configured to determine whether the view requires re-exposure;
a re-determining exposure state module configured to, in response to the view requiring re-exposure, re-determine a current exposure state of the view based on the historical exposure state of the view and an exposure related parameter of the view.

In some embodiments of the present disclosure, the display state changing comprises an appearance event and a disappearance event;
the determining module 502 may include:
an appearance unit configured to, in response to detecting an appearance event of the list view, determine the current exposure state of the list view to be in exposure;
and a disappearance unit configured to, in response to detecting a disappearance event of the list view, determine the current exposure state of the list view based on the historical exposure state of the list view and the exposure related parameter of the list view.

In some embodiments of the present disclosure, the exposure related parameter comprises an exposure time of the view;

the disappearance unit comprises:
in response to the historical exposure state of the list view being in exposure, and the exposure time being greater than or equal to a third threshold, determining the current exposure state of the list view to be exposed;
in response to the historical exposure state of the list view being in exposure, and the exposure time being less than the third threshold, determining the current exposure state of the list view to be unexposed.

In some embodiments of the present disclosure, the apparatus further comprises:
a scroll stop module configured to, in response to detecting a scroll stop event of the list view, poll the historical exposure states of all list views of the page on which the list view is located, and determine a current exposure state of each of the list views based on the historical exposure state and the exposure related parameter of each of the list views.

In some embodiments of the present disclosure, the exposure related parameter comprises an exposure area of the view, a transparency of the view, and a location of the view;
the polling module 504 comprises:
a second determining unit configured to, for each of the list views, in response to the historical exposure state of the list view being in exposure, and the exposure area being less than a first threshold, the transparency being less than a second threshold, and the location is not on a visible page, determine the current exposure state of the list view to be unexposed.

In some embodiments of the present disclosure, the polling module 504 further comprises:
a re-exposure control unit configured to, for each of the list views, obtain a re-exposure parameter of the list view; determine the current exposure state of the list view based on the re-exposure parameter, the historical exposure state, and the exposure related parameter; wherein the re-exposure configuration comprises: an in-single-page re-exposure parameter, a background return re-exposure parameter, a page return re-exposure parameter, and a program active re-exposure parameter; the in-single-page re-exposure parameter is used to control whether the list view in a single page is re-exposed; the background return re-exposure parameter is used to control whether the list view displayed after being returned by the background is re-exposed; the page return re-exposure parameter is used to control whether the list view displayed after returning to a page is re-exposed; the program active re-exposure parameter is used to control whether the list view displayed after a program is active is re-exposed.

In some embodiments of the present disclosure, the apparatus further comprises:
a setting module configured to set a target view, the target view being located on a first page;
a page switching module configured to, in response to an event of switching the first page to a second page, re-determine a current exposure state of the target view; wherein the first page and the second page are controlled by a same view controller.

For ease of description, the foregoing apparatus is described by dividing functions into various modules for separate description. Definitely, in a case that the present disclosure is implemented, functions of each module may be implemented in one or more pieces of software and/or hardware.

The device of the described embodiment is used to implement the method for determining the corresponding view exposure in any one of the described embodiments, and has the beneficial effect of the corresponding method embodiment, which will not be repeated here.

Based on the same inventive concept, corresponding to the method of any of the above embodiments, the present disclosure further provides an electronic device, comprising a memory, a processor and a computer program stored in the memory and operable on the processor, wherein when executing the program, the processor implements the method for determining view exposure according to any of the above embodiments.

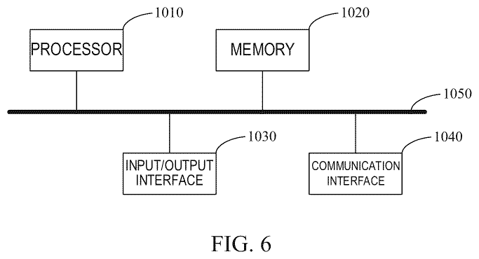

FIG. 6 is a schematic structural diagram of more specific hardware of an electronic device according to an embodiment of the present invention. The device may include: a processor 1010, a memory 1020, an input/output interface 1030, a communications interface 1040, and a bus 1050. The processor 1010, the storage 1020, the input/output interface 1030, and the communications interface 1040 are connected to each other inside the device through the bus 1050.

The processor 1010 may be implemented by using a universal CPU (Central Processing Unit), a microprocessor, an application specific integrated circuit (ASIC), or one or more integrated circuits, and is configured to execute a relevant program, so as to implement the technical solutions provided in the embodiments of the specification.

The memory 1020 may be implemented in the form of a ROM (Read Only Memory), a RAM (Random Access Memory), a static storage device, and a dynamic storage device. The memory 1020 may store an operating system and other application programs. In a case that the technical solutions provided in the embodiments of the present invention are implemented by software or firmware, related program codes are stored in the memory 1020 and invoked and executed by the processor 1010.

The input/output interface 1030 is configured to connect to an input/output module to input and output information. The input/output module may be configured in a device (not shown in the figure) as a component, and may also be externally connected to the device to provide corresponding functions. The input device may include a keyboard, a mouse, a touch screen, a microphone, various sensors, and the like, and the output device may include a display, a speaker, a vibrator, an indicator lamp, and the like.

The communications interface 1040 is configured to connect to a communications module (not shown in the figure), so as to implement communication and interaction between this device and another device. The communication module may implement communication in a wired manner (such as a USB and a network cable), and may also implement communication in a wireless manner (such as a mobile network, WIFI, and Bluetooth).

The bus 1050 may comprise a pathway that may enable communication of information between various components of the device, for example, the processor 1010, the memory 1020, the input/output interface 1030, and the communication interface 1040.

It should be noted that, although the foregoing device only shows the processor 1010, the memory 1020, the input/output interface 1030, the communications interface 1040, and the bus 1050, in a specific implementation process, the device can further include other components necessary for implementing normal running. In addition, a person skilled in the art may understand that the foregoing device may also only include components necessary for implementing solutions of embodiments of the present specification, and does not necessarily include all components shown in the figure.

The electronic device in the foregoing embodiment is used to implement the method for determining a corresponding view exposure in any one of the foregoing embodiments, and has beneficial effects of a corresponding method embodiment, which are not described herein again.

Based on the same inventive concept, corresponding to the method of any of the above embodiments, the present disclosure further provides a non-transitory computer-readable storage medium. The non-transitory computer-readable storage medium stores a computer instruction, and the computer instruction is used for enabling the computer to execute the method for determining view exposure according to any of the above embodiments.

The computer readable media of this embodiment, including both persistent and non-persistent, removable and non-removable media, may be any method or technology for storage of information. The information may be computer readable instructions, data structures, modules of a program, or other data. Examples of computer storage media include, but not limited to phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disc read-only memory (CD-ROM), digital versatile discs (DVD) or other optical storage, magnetic cassettes, magnetic tape magnetic disk storage or other magnetic storage devices, or any other non-transmission medium, may be used to store information that may be accessed by a computing device.

The computer instruction stored in the storage medium in the foregoing embodiment is used to enable the computer to execute the method for determining view exposure according to any one of the foregoing embodiments, and has beneficial effects of a corresponding method embodiment, which are not described herein again.

Based on the same inventive concept, corresponding to the method for determining a view exposure according to any embodiment, the present disclosure further provides a computer program product, which includes a computer program instruction. In some embodiments, the computer program instructions may be executable by one or more processors of a computer to cause the computer and/or the processors to perform the described method of determining view exposures. Corresponding to an execution subject corresponding to each step in each embodiment of the method for determining a view exposure, a processor for executing a corresponding step may belong to the corresponding execution subject.

The computer program product in the foregoing embodiment is used to enable the computer and/or the processor to execute the method for determining view exposure according to any one of the foregoing embodiments, and has beneficial effects of a corresponding method embodiment, which are not described herein again.

It should be understood by one of ordinary skill in the art that the discussion of any embodiment above is merely exemplary and is not intended to imply that the scope of the present disclosure, including the claims, is limited to these examples; in the concept of the present disclosure, the technical features in the above embodiments or different embodiments may also be combined, the steps may be implemented in any order, and there are many other variations on different aspects of the embodiments of the present disclosure as described above, which are not provided in detail for simplicity.

In addition, well-known power/ground connections to integrated circuit (IC) chips and other components may or may not be shown in the provided drawings for simplicity of illustration and discussion, and so as not to obscure embodiments of the present disclosure. Furthermore, the apparatus may be shown in block diagram form in order to avoid obscuring embodiments of the present disclosure, and this also takes into account the fact that specifics with respect to embodiments of these block diagram apparatus are highly dependent upon the platform on which the embodiments of the present disclosure are to be implemented (i.e., such specifics should be well within purview of those skilled in the art). Where specific details (e.g., circuits) are set forth in order to describe example embodiments of the disclosure, it should be apparent to those skilled in the art that embodiments of the disclosure may be practiced without, or with variation of, these specific details. Therefore, these descriptions should be regarded as illustrative rather than restrictive.

Although the present disclosure has been described in conjunction with specific embodiments of the present disclosure, many alternatives, modifications, and variations of these embodiments will be apparent to those of ordinary skill in the art in light of the foregoing description. For example, other memory architectures (e.g., dynamic RAM (DRAM)) may use the discussed embodiments.

It is intended that embodiments of the present disclosure cover all such alternatives, modifications and variations as belong to the broad scope of the appended claims. Therefore, any omissions, modifications, equivalent replacements and improvements made without departing from the spirit and principle of the embodiments of the present disclosure shall belong to the scope of protection of the present disclosure.

I/We claim:

1. A method for determining a view exposure state, comprising:
in response to detecting that a display state of a view changes, determining a current exposure state of the view based on a historical exposure state of the view and an exposure related parameter of the view, the historical exposure state comprising an exposure state of the view before the display state of the view changes, the view comprising a list view; and
polling, at a predetermined time interval, the historical exposure states of all list views of a page on which the list view is located, and determining a current exposure state of each of the list views based on the historical exposure state and the exposure related parameter of each of the list views.

2. The method of claim 1, wherein the exposure related parameter comprises an exposure area of the view, a transparency of the view, and a location of the view;
determining the current exposure state of the view based on the historical exposure state of the view and the exposure related parameter of the view comprises:
in response to the exposure area being greater than a first threshold, the transparency being greater than a second threshold, and the location being on a visible page, determining the current exposure state of the view to be exposed.

3. The method of claim 2, wherein after determining the current state of the view to be exposed, the method further comprises:
determining whether the view requires re-exposure;
in response to the view requiring re-exposure, re-determining a current exposure state of the view based on the historical exposure state of the view and an exposure related parameter of the view.

4. The method of claim 1, wherein the display state changing comprises an appearance event and a disappearance event;
in response to detecting that the display state of the view changes, determining the current exposure state of the view based on the historical exposure state of the view and the exposure-related parameter of the view comprises:
in response to detecting an appearance event of the list view, determining the current exposure state of the list view to be in exposure;
in response to detecting a disappearance event of the list view, determining the current exposure state of the list view based on the historical exposure state of the list view and the exposure related parameter of the list view.

5. The method of claim 4, wherein the exposure related parameter comprises an exposure time of the view;
determining the current exposure state of the list view based on the historical exposure state of the list view and the exposure related parameter of the list view comprises:
in response to the historical exposure state of the list view being in exposure, and the exposure time being greater than or equal to a third threshold, determining the current exposure state of the list view to be exposed;
in response to the historical exposure state of the list view being in exposure, and the exposure time being less than the third threshold, determining the current exposure state of the list view to be unexposed.

6. The method of claim 1, further comprising:
in response to detecting a scroll stop event of the list view, polling the historical exposure states of all list views of the page on which the list view is located, and determining a current exposure state of each of the list views based on the historical exposure state and the exposure related parameter of each of the list views.

7. The method of claim 1, wherein the exposure related parameter comprises an exposure area of the view, a transparency of the view, and a location of the view;
determining the current exposure state of each of the list views based on the historical exposure state and the exposure related parameter of each of the list views comprises:
for each of the list views, in response to the historical exposure state of the list view being in exposure, and the exposure area being less than a first threshold, the transparency being less than a second threshold, and the location is not on a visible page, determining the current exposure state of the list view to be unexposed.

8. The method of claim 1, wherein determining the current exposure state of each of the list views based on the historical exposure state and the exposure related parameter of each of the list views further comprises:
for each of the list views, obtaining a re-exposure parameter of the list view; determining the current exposure state of the list view based on the re-exposure parameter, the historical exposure state, and the exposure related parameter; wherein the re-exposure configuration comprises: an in-single-page re-exposure parameter, a background return re-exposure parameter, a page return re-exposure parameter, and a program active re-exposure parameter; the in-single-page re-exposure parameter is used to control whether the list view in a single page is re-exposed; the background return re-exposure parameter is used to control whether the list view displayed after being returned by the background is re-exposed; the page return re-exposure parameter is used to control whether the list view displayed after returning to a page is re-exposed; the program active re-exposure parameter is used to control whether the list view displayed after a program is active is re-exposed.

9. The method of claim 1, further comprising:
setting a target view, the target view being located on a first page;
in response to an event of switching the first page to a second page, re-determining a current exposure state of the target view; wherein the first page and the second page are controlled by a same view controller.

10. An electronic device comprising a memory, a processor, and a computer program stored in the memory and executable on the processor, wherein when executing the program, the processor implements a method for determining a view exposure state, comprising:
in response to detecting that a display state of a view changes, determining a current exposure state of the view based on a historical exposure state of the view and an exposure related parameter of the view, the historical exposure state comprising an exposure state of the view before the display state of the view changes, the view comprising a list view; and
polling, at a predetermined time interval, the historical exposure states of all list views of a page on which the list view is located, and determining a current exposure state of each of the list views based on the historical exposure state and the exposure related parameter of each of the list views.

11. The electronic device of claim 10, wherein the exposure related parameter comprises an exposure area of the view, a transparency of the view, and a location of the view;
determining the current exposure state of the view based on the historical exposure state of the view and the exposure related parameter of the view comprises:
in response to the exposure area being greater than a first threshold, the transparency being greater than a second threshold, and the location being on a visible page, determining the current exposure state of the view to be exposed.

12. The electronic device of claim 11, wherein after determining the current state of the view to be exposed, the method further comprises:
determining whether the view requires re-exposure;
in response to the view requiring re-exposure, re-determining a current exposure state of the view based on the historical exposure state of the view and an exposure related parameter of the view.

13. The electronic device of claim 10, wherein the display state changing comprises an appearance event and a disappearance event;
in response to detecting that the display state of the view changes, determining the current exposure state of the view based on the historical exposure state of the view and the exposure-related parameter of the view comprises:
in response to detecting an appearance event of the list view, determining the current exposure state of the list view to be in exposure;
in response to detecting a disappearance event of the list view, determining the current exposure state of the list view based on the historical exposure state of the list view and the exposure related parameter of the list view.

14. The electronic device of claim 13, wherein the exposure related parameter comprises an exposure time of the view;
determining the current exposure state of the list view based on the historical exposure state of the list view and the exposure related parameter of the list view comprises:
in response to the historical exposure state of the list view being in exposure, and the exposure time being greater than or equal to a third threshold, determining the current exposure state of the list view to be exposed;
in response to the historical exposure state of the list view being in exposure, and the exposure time being less than the third threshold, determining the current exposure state of the list view to be unexposed.

15. The electronic device of claim 10, wherein the method further comprises:
in response to detecting a scroll stop event of the list view, polling the historical exposure states of all list views of the page on which the list view is located, and determining a current exposure state of each of the list views based on the historical exposure state and the exposure related parameter of each of the list views.

16. The electronic device of claim 10, wherein the exposure related parameter comprises an exposure area of the view, a transparency of the view, and a location of the view;
determining the current exposure state of each of the list views based on the historical exposure state and the exposure related parameter of each of the list views comprises:
for each of the list views, in response to the historical exposure state of the list view being in exposure, and the exposure area being less than a first threshold, the transparency being less than a second threshold, and the location is not on a visible page, determining the current exposure state of the list view to be unexposed.

17. The electronic device of claim 10, wherein determining the current exposure state of each of the list views based on the historical exposure state and the exposure related parameter of each of the list views further comprises:
for each of the list views, obtaining a re-exposure parameter of the list view; determining the current exposure state of the list view based on the re-exposure parameter, the historical exposure state, and the exposure related parameter; wherein the re-exposure configuration comprises: an in-single-page re-exposure parameter, a background return re-exposure parameter, a page return re-exposure parameter, and a program active re-exposure parameter; the in-single-page re-exposure parameter is used to control whether the list view in a single page is re-exposed; the background return re-exposure parameter is used to control whether the list view displayed after being returned by the background is re-exposed; the page return re-exposure parameter is used to control whether the list view displayed after returning to a page is re-exposed; the program active re-exposure parameter is used to control whether the list view displayed after a program is active is re-exposed.

18. The electronic device of claim 10, wherein the method further comprises:
setting a target view, the target view being located on a first page;
in response to an event of switching the first page to a second page, re-determining a current exposure state of the target view; wherein the first page and the second page are controlled by a same view controller.

19. A non-transitory computer readable storage medium, wherein the non-transitory computer readable storage medium stores computer instructions, wherein the computer instructions are used to cause a computer to implement a method for determining a view exposure state, comprising:
in response to detecting that a display state of a view changes, determining a current exposure state of the view based on a historical exposure state of the view and an exposure related parameter of the view, the historical exposure state comprising an exposure state of the view before the display state of the view changes, the view comprising a list view; and
polling, at a predetermined time interval, the historical exposure states of all list views of a page on which the list view is located, and determining a current exposure state of each of the list views based on the historical exposure state and the exposure related parameter of each of the list views.
